(19) United States
(12) Patent Application Publication
(10) Pub. No.: US 2016/0305607 A1
(43) Pub. Date: Oct. 20, 2016

(54) COUPLING GUARD

(71) Applicant: Ebara Corporation, Tokyo (JP)

(72) Inventors: Seigo Kyo, Tokyo (JP); Yoichi Nakamura, Tokyo (JP)

(21) Appl. No.: 15/097,629

(22) Filed: Apr. 13, 2016

(30) Foreign Application Priority Data
Apr. 16, 2015 (JP) 2015-084466

(51) Int. Cl. F16P 1/02

(52) U.S. Cl. CPC F16P 1/02

(57) ABSTRACT

A coupling guard capable of adjusting its length with a simple structure is disclosed. The coupling guard for covering a coupling which couples a drive shaft of a prime mover and a rotational shaft of a rotary machine to each other, includes: a guard body including an upper semicylindrical member and a lower semicylindrical member, the guard body having a fastening tool configured to couple the upper semicylindrical member and the lower semicylindrical member to each other; a guard leg configured to support the guard body; and a length adjustment member inserted into the guard body. The length adjustment member has a cylindrical shape. The length adjustment member has an outer circumferential surface which is tightened by inner circumferential surfaces of the upper semicylindrical member and the lower semicylindrical member which are coupled by the fastening tool.

### CROSS REFERENCE TO RELATED APPLICATION

This document claims priority to Japanese Patent Application No. 2015-084466 filed Apr. 16, 2015, the entire contents of which are hereby incorporated by reference.

### BACKGROUND

There has been known a machine apparatus in which a rotational shaft of a rotary machine is coupled to a drive shaft of a prime mover through a coupling (or a shaft coupling) and the drive shaft is rotated to thereby rotate the rotational shaft. One example of such a machine apparatus is a pump apparatus. The pump apparatus includes a motor which is a prime mover, and a pump which is a rotary machine A drive shaft of the motor is coupled to a rotational shaft of the pump by the coupling. In the pump apparatus, a torque of the drive shaft of the motor is transmitted to the rotational shaft of the pump through the coupling, thereby rotating an impeller which is fixed to the rotational shaft.

Usually, a coupling guard, which covers the coupling and a vicinity of the coupling, is provided so that a human being does not touch the coupling, an exposed portion of the rotational shaft of the pump, and an exposed portion of the drive shaft of the motor when they are rotating at a high speed.

In pump apparatuses which use the same standardized pumps and the same standardized motors, the same standardized coupling guards can be used, because a distance between each pump and each motor is constant. However, a motor, which is different from the standardized motors, may be used according to a requirement of a user. In this case, the standardized coupling guard may not cover the exposed rotational shaft and/or drive shaft, because the distance between the pump and the motor is changed. This problem can occur not only in the pump apparatus, but also in all machinery which uses a coupling through which a rotational shaft of a rotary machine is coupled to a drive shaft of a prime mover.

### SUMMARY OF THE INVENTION

According to an embodiment, there is provided a coupling guard capable of adjusting its length with a simple structure.

Embodiments, which will be described below, relate to a coupling guard for covering a coupling which is used to couple a rotational shaft of a rotary machine, such as a pump, to a drive shaft of a prime mover, such as a motor.

In an embodiment, there is provided a coupling guard for covering a coupling which couples a drive shaft of a prime mover and a rotational shaft of a rotary machine to each other, the coupling guard comprising: a guard body including an upper semicylindrical member and a lower semicylindrical member, the guard body having a fastening tool configured to couple the upper semicylindrical member and the lower semicylindrical member to each other; a guard leg configured to support the guard body; and a length adjustment member inserted into the guard body, the length adjustment member having a cylindrical shape, the length adjustment member having an outer circumferential surface which is tightened by inner circumferential surfaces of the upper semicylindrical member and the lower semicylindrical member which are coupled by the fastening tool.

In an embodiment, the length adjustment member includes: a single plate which has been bent into a cylindrical shape; protrusions formed on both ends of the plate, respectively; and a fixing mechanism configured to fix the protrusions to each other.

In an embodiment, the protrusions extend outwardly in a radial direction of the plate in the cylindrical shape, and are in contact with each other, and the both ends of the plate are in contact with each other.

In an embodiment, the fixing mechanism includes a bolt inserted into through-holes formed in the protrusions, and a nut engaging with the bolt.

In an embodiment, the coupling guard further comprises a support leg configured to support the length adjustment member, the support leg being secured to the protrusions.

In an embodiment, the fixing mechanism comprises cutouts which engage with each other, the cutouts being formed in the protrusions, respectively.

In an embodiment, the length adjustment member comprises at least two segments which are coupled to each other to have a cylindrical shape.

In an embodiment, the plate is made of metal.

According to the above-described embodiments, the length of the coupling guard can be easily adjusted with a simple structure in which the outer circumferential surface of the length adjustment member is simply tightened by the inner circumferential surface of the guard body. Moreover, since the length adjustment member can be fixed to the guard body at a desired position, the length of the coupling guard can be adjusted in a non-step manner.

### BRIEF DESCRIPTION OF THE DRAWINGS

FIG. 1 is a schematic perspective view of a pump apparatus including a coupling guard according to an embodiment;

FIG. 2 is a side view of the coupling guard shown in FIG. 1;

FIG. 3 is a cross-sectional view taken along line A-A in FIG. 2;

FIG. 4A is a front view of a length adjustment member according to an embodiment;

FIG. 4B is a side view of the length adjustment member shown in FIG. 4A;

FIG. 5 is a schematic view showing a plate which constitutes the length adjustment member shown in FIGS. 4A and 4B;

FIG. 6 is a perspective view showing a state in the middle of assembly of the coupling guard;

FIG. 7 is a perspective view of a support leg for supporting the length adjustment member;

FIG. 8 is a schematic view showing a state in which the support leg shown in FIG. 7 is attached to the length adjustment member;

FIG. 9A is a front view of a length adjustment member according to another embodiment;

FIG. 9B is a side view of the length adjustment member shown in FIG. 9A;

FIG. 10 is a schematic view showing a plate which constitutes the length adjustment member shown in FIGS. 9A and 9B;

FIG. 11A is a front view of a length adjustment member according to still another embodiment; and

FIG. 11B is a side view of the length adjustment member shown in FIG. 11A.

### DESCRIPTION OF THE EMBODIMENTS

Embodiments will be described below with reference to the drawings.

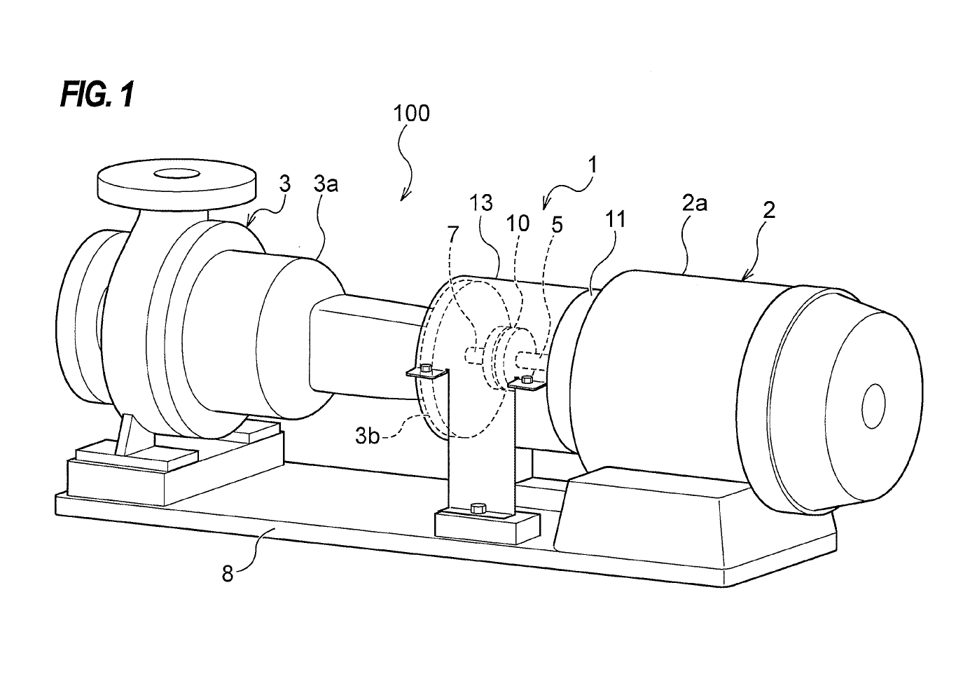

FIG. 1 is a schematic perspective view of a pump apparatus 100 including a coupling guard 1 according to an embodiment. The pump apparatus 100 includes a motor 2 which is a prime mover, and a pump 3 which is a rotary machine. The motor 2 and the pump 3 are fixedly mounted to a base 8. A drive shaft 5 of the motor 2 extends from a motor casing 2a of the motor 2 toward the pump 3. A rotational shaft 7 of the pump 3 extends from a pump casing 3a of the pump 3 toward the motor 2. The drive shaft 5 of the motor 2 is coupled to the rotational shaft 7 of the pump 3 by a coupling (or a shaft coupling) 10. In this embodiment, a central axis of the rotational shaft 7 of the pump 3 is aligned with a center axis of the drive shaft 5 of the motor 2.

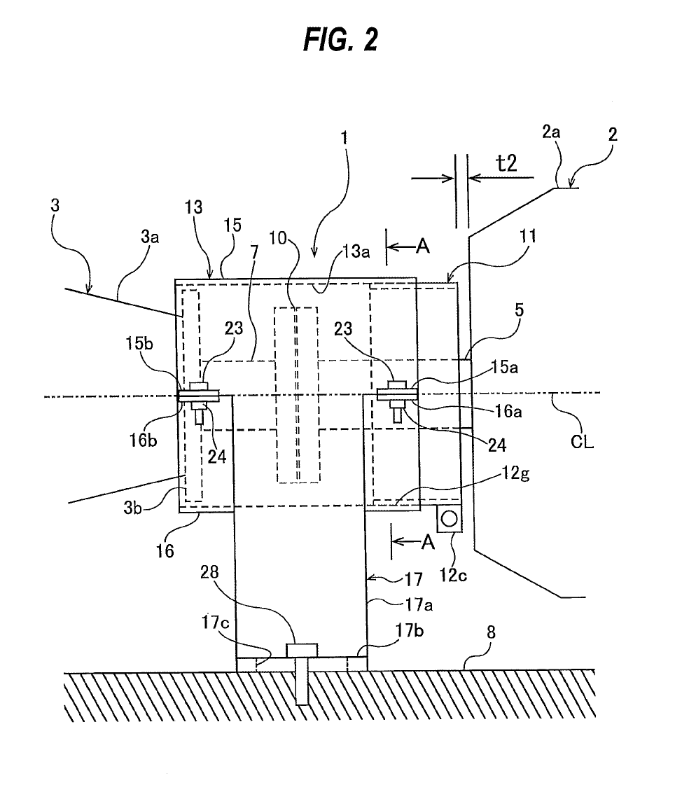

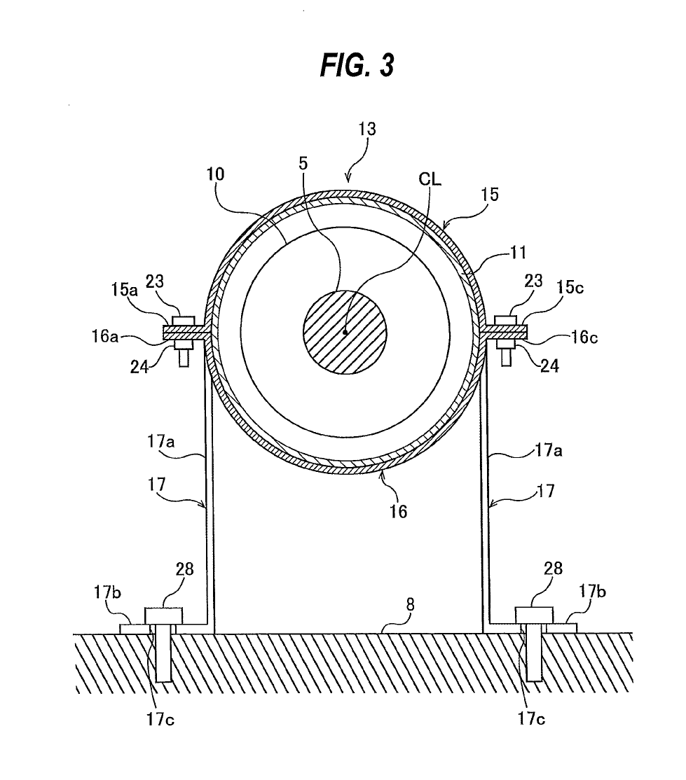

The coupling 10, an exposed portion of the drive shaft 5 of the motor 2, and an exposed portion of the rotational shaft 7 of the pump 3 are covered with the coupling guard 1. The coupling guard 1 will be described below with reference to FIG. 2 and FIG. 3. FIG. 2 is a side view of the coupling guard 1 shown in FIG. 1, and FIG. 3 is a cross-sectional view taken along line A-A in FIG. 2. The coupling guard 1 includes a guard body 13 having a cylindrical shape, and two guard legs 17 for supporting the guard body 13. In FIG. 2, a common central axis of the cylindrical guard body 13, the rotational shaft 7 of the pump 3, and the drive shaft 5 of the motor 2 is depicted by a two-dot chain line denoted by symbol CL.

The guard body 13 includes an upper semicylindrical member 15, a lower semicylindrical member 16 which is attachable to and detachable from the upper semicylindrical member 15, and bolts 23 and nuts 24 which serve as fastening tool for coupling the upper semicylindrical member 15 and the lower semicylindrical member 16 to each other. The upper semicylindrical member 15 has, at its lower end, four upper flange portions 15a, 15b, 15c, and 15d, which protrude outwardly in radial direction of the upper semicylindrical member 15 from its lower end. Although only two upper flange portions 15a, 15b are illustrated in FIG. 2, the upper flange portions 15c, 15d are formed at the opposite side from the upper flange portions 15a, 15b.

The lower semicylindrical member 16 has, at its upper end, four lower flange portions 16a, 16b, 16c, and 16d, which protrude outwardly in radial direction of the lower semicylindrical member 16 from its upper end. The lower flange portions 16a, 16b, 16c, and 16d are formed at positions corresponding to positions of the upper flange portions 15a, 15b, 15c, and 15d, respectively. The upper flange portions 15a, 15b, 15c, and 15d are fixed to the lower flange portions 16a, 16b, 16c, and 16d by bolts 23 and nuts 24 engaging with the bolts 23, whereby the upper semicylindrical member 15 and the lower semicylindrical member 16 are coupled to each other. When the bolts 23 and the nuts 24 are disengaged from each other, the upper half-cylinder member 15 and the lower semicylindrical member 16 can be separated from each other.

Each guard leg 17 includes a guard leg body 17a and a fixing portion 17b. In this embodiment, the guard leg 17 is integral with the upper semicylindrical member 15. The guard leg body 17a is a flat plate which extends downwardly from the lower end of the upper semicylindrical member 15. The fixing portion 17b extends from a lower end of the guard leg body 17a in a horizontal direction and in a direction away from the central axis CL. An elongate hole 17c for fixing the guard leg 17 to the base 8 is formed in the fixing portion 17b. This elongate hole 17c extends parallel to the central axis CL. The bolt 28, which is inserted into the elongate hole 17c, is engaged with a threaded hole formed in the base 8 to thereby secure the guard leg 17 to the base 8.

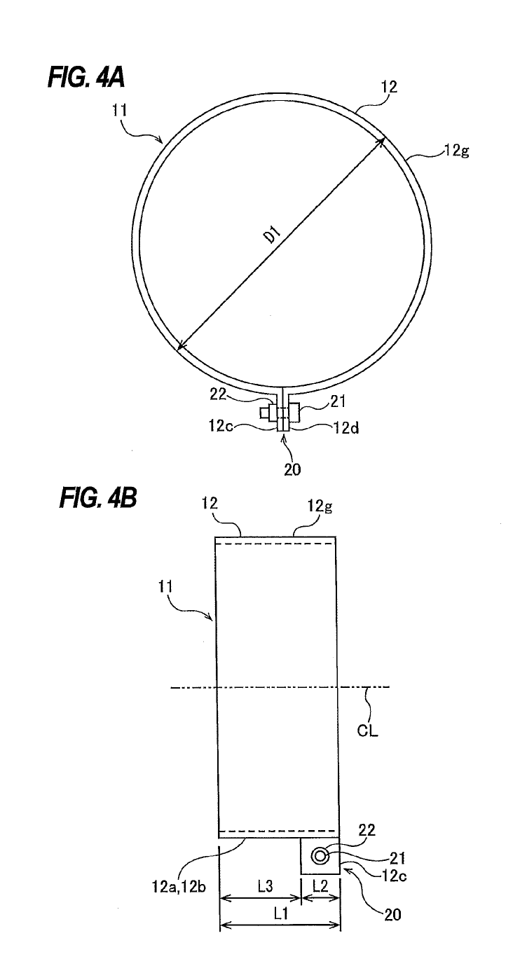

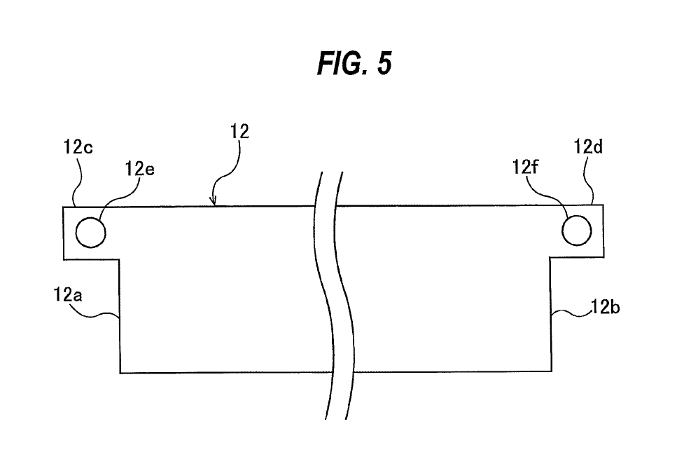

The coupling guard 1 further includes a length adjustment member 11 for adjusting a length of the coupling guard 1 in a direction of the central axis CL. The length adjustment member 11, with its part inserted in the guard body 13, is fixed to the guard body 13. The length adjustment member 11 will be described below with reference to FIG. 4A, FIG. 4B, and FIG. 5. FIG. 4A is a front view of the length adjustment member 11 according to an embodiment, FIG. 4B is a side view of the length adjustment member 11 shown in FIG. 4A, and FIG. 5 is a schematic view showing a plate which constitutes the length adjustment member shown in FIGS. 4A and 4B.

As shown in FIGS. 4A and 4B, the length adjustment member 11 has a cylindrical shape. The length adjustment member 11 includes a single plate 12 which has been bent into a cylindrical shape, protrusions 12c, 12d which are formed on both ends 12a, 12b of the plate 12, respectively, and a fixing mechanism 20 for fixing these protrusions 12c, 12d to each other. The rectangular plate 12 shown in FIG. 5 is bent into the cylindrical shape, and the both ends 12a, 12b of the plate 12 are in contact with each other. The protrusions 12c, 12d are connected to the both ends 12a, 12b of the plate 12, respectively. The protrusions 12c, 12d are integral with the plate 12.

As shown in FIGS. 4A and 4B, the protrusions 12c, 12d extend outwardly in the radial direction of the cylindrically-bent plate 12 and the guard body 13, and are in contact with each other. The fixing mechanism 20 includes a bolt 21 which is inserted into through-holes 12e, 12f (see FIG. 5) formed in the protrusions 12c, 12d, respectively, and a nut 22 which engages with the bolt 21.

As shown in FIG. 4B, a length L2 of the protrusions 12c, 12d in the direction of the central axis CL is shorter than a length L1 of the plate 12 in the direction of the central axis CL. A portion of the plate 12 where the protrusions 12c, 12d are not formed is inserted into the guard body 13 and is held by the guard body 13. A length L3 of this portion corresponds to a distance which can adjust a length of the coupling guard 1.

When the rectangular plate 12 shown in FIG. 5 is formed into the cylindrical shape, the protrusions 12c, 12d are folded outwardly so as to make contact with each other (see FIG. 4A). When the protrusions 12c, 12d are in contact with each other, the both ends 12a, 12b are in contact with each other. The through-hole 12e, which is formed in the protrusion 12c, is located at the same position as the position of the through-hole 12f formed in the protrusion 12d, so that the bolt 21 can be inserted into the through-hole 12e and the through-hole 12f. The bolt 21, inserted into the through-hole 12e and the through-hole 12f, is tightened with the nut 22, whereby the cylindrical shape of the plate 12 is maintained.

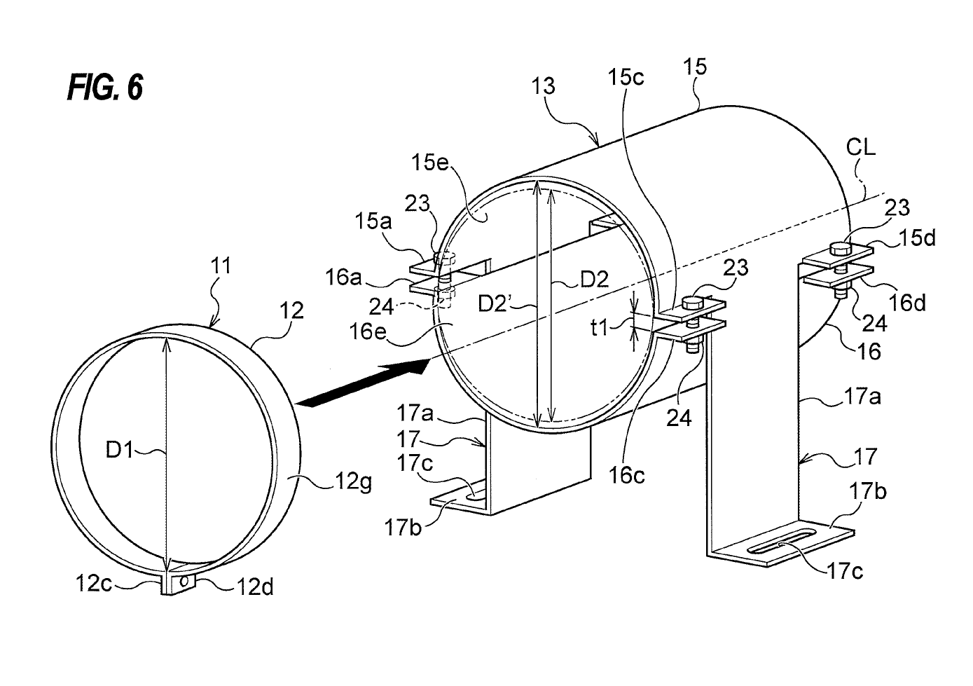

Next, a method for assembling the coupling guard 1 will be described. First, the lower semicylindrical member 16 is positioned below the coupling 10. Next, one of the two guard legs 17, which are integral with the upper semicylindrical member 15, is inserted between the lower flange portions 16a, 16b of the lower semicylindrical member 16, and the other of the two guard legs 17 is inserted between the lower flange portions 16c, 16d (see FIG. 6) of the lower semicylindrical member 16. The lower semicylindrical member 16 is moved toward the upper semicylindrical member 15 until the lower flange portions 16a, 16b, 16c, and 16d are brought into contact with the upper flange portions 15a, 15b, 15c, and 15d. The bolts 23 are inserted into the upper flange portions 15a, 15b, 15c, and 15d, and the lower flange portions 16a, 16b, 16c, and 16d, respectively, and the nuts 24 are then engaged with the bolts 23, respectively. At this stage, the nuts 24 loosely engage with the bolts 23 such that a gap is formed between the upper semicylindrical member 15 and the lower semicylindrical member 16. FIG. 6 illustrates this state. As shown in FIG. 6, a vertical gap t1 is formed between the upper semicylindrical member 15 and the lower semicylindrical member 16.

Next, the nut 22 is removed from the bolt 21, both of which constitute the fixing mechanism 20 of the length adjustment member 11, to separate the protrusions 12c, 12d from each other, and the drive shaft 5 of the motor 2 is passed through a space between the protrusions 12c, 12d. Next, the both ends 12a, 12b of the plate 12 are brought into contact with each other. The bolt 21 is inserted into the through-hole 12e formed in the protrusion 12c and the through-hole 12f formed in the protrusion 12d, and the nut 22 is then engaged with the bolt 21. The nut 22 is completely tightened to the bolt 21. As a result, the plate 12 is formed into the cylindrical shape as shown in FIGS. 4A and 4B.

Symbol D2 shown in FIG. 6 represents a diameter of an inner circumferential surface 13a of the guard body 13 when the upper semicylindrical member 15 and the lower semicylindrical member 16 are coupled to each other by the bolts 23 and the nuts 24 and when the length adjustment member 11 is not inserted into the guard body 13. The inner circumferential surface 13a of the guard body 13 is constituted by an inner circumferential surface 15e of the upper semicylindrical member 15 and an inner circumferential surface 16e of the lower semicylindrical member 16. Symbol D2′ represents a distance between an uppermost portion of the inner circumferential surface 15e of the upper semicylindrical member 15 and a lowermost portion of the inner circumferential surface 16e of the lower semicylindrical member 16. Symbol D1 represents a diameter of an outer circumferential surface 12g of the length adjustment member 11 having the cylindrical shape. The length of the plate 12 of the length adjustment member 11 is designed such that the diameter D1 is slightly larger than the diameter D2 of the inner circumferential surface 13a of the guard body 13.

The distance D2′ represents a length that is obtained by adding a magnitude of the gap t1 in the vertical direction, which is formed between the upper semicylindrical member 15 and the lower semicylindrical member 16, to the diameter D2 of the inner circumferential surface 13a of the guard body 13. While the gap t1 is formed such that the distance D2′ is larger than the diameter D1 of the outer circumferential surface 12g of the length adjustment member 11, the portion of the length adjustment member 11, at which the protrusions 12c, 12d are not formed, is inserted between the upper semicylindrical member 15 and the lower semicylindrical member 16. The nuts 24 are then completely tightened to the bolts 23.

When the nuts 24 are completely tightened to the bolts 23, a pressing force, which acts to reduce the diameter of the length adjustment member 11, is applied from the inner circumferential surface 13a of the guard body 13 to the outer circumferential surface 12g of the length adjustment member 11, because the diameter D2 of the inner circumferential surface 13a of the guard body 13 is smaller than the diameter D1 of the outer circumferential surface 12g of the length adjustment member 11. Accordingly, a repulsive force, which acts to expand the guard body 13, is generated in the length adjustment member 11, whereby the length adjustment member 11 is tightly held on the guard body 13. More specifically, by tightening the outer circumferential surface 12g of the length adjustment member 11 with the inner circumferential surface 13a of the guard body 13, the length adjustment member 11 is fixed to the guard body 13.

Because the outer circumferential surface 12g of the length adjustment member 11 is simply tightened by the inner circumferential surface 13 of the guard body 13, a position of the length adjustment member 11 relative to the guard body 13 can be changed freely by once loosening the bolts 23 and the nuts 24. Therefore, the length adjustment member 11 can freely increase or decrease (i.e., adjust) the length of the coupling guard 1 in the direction of the central axis CL.

As shown in FIG. 2, the coupling guard 1 is opposite the motor casing 2a of the motor 2 with a gap t2 formed therebetween. A magnitude of the gap t2 formed between the coupling guard 1 and the motor casing 2a of the motor 2 is preferably not more than 8 mm. With the magnitude of the gap t2 of not more than 8 mm, it is possible to prevent a finger of a human being from entering the gap t2. As a result, it is possible to prevent a human being from touching the drive shaft 5 of the motor 2 and the coupling 10. According to this embodiment, the length adjustment member 11 can easily enable the gap t2 between the motor casing 2a of the motor 2 and the coupling guard 1 to have a magnitude of 8 mm or less.

If the length adjustment member 11 touches the motor casing 2a, a vibration of the motor 2 is transmitted to the coupling guard 1. As a result, the coupling guard 1 may become a source of noise. Moreover, the length adjustment member 11 and/or the motor casing 2a may be worn. Therefore, it is preferred that the length adjustment member 11 be not in contact with the motor casing 2a.

As shown in FIG. 2, a pump-side opening of the guard body 13 is closed with a flange 3b provided on a casing 3a of the pump 3. This flange 3b makes it possible to prevent a human being from touching the rotational shaft 7 of the pump 3 and the coupling 10. Although not shown, instead of the flange 3b, a circular closure plate, which has a through-hole through which the rotational shaft 7 of the pump 3 extends, may be fixed to the guard body 13.

As discussed above, since the position of the length adjustment member 11 relative to the guard body 13 can be changed freely, the length of the coupling guard 1 in the direction of the central axis CL can be adjusted in a non-step manner. Moreover, the length of the coupling guard 1 in the direction of the central axis CL can be adjusted with a simple structure in which the outer circumferential surface 12g of the length adjustment member 11 is simply tightened by the inner circumferential surface 13a of the guard body 13. In order to generate a large repulsive force in the length adjustment member 11, it is preferred that the length adjustment member 11 be made of a relatively rigid metal.

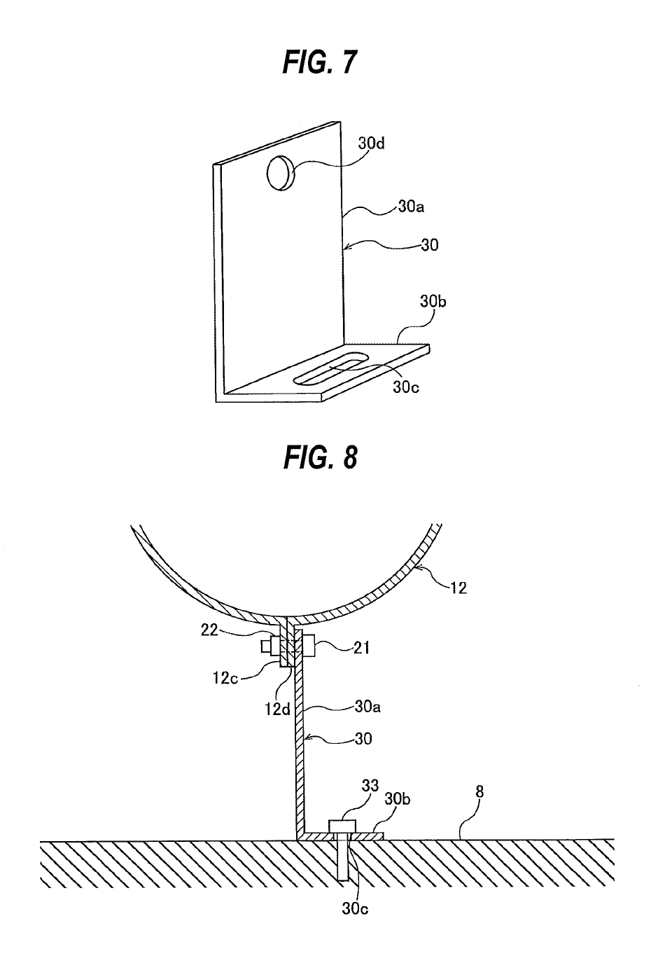

A support leg 30, which is shown in FIG. 7, for supporting the length adjustment member 11 may be provided. FIG. 7 is a perspective view of the support leg 30 for supporting the length adjustment member 11. The support leg 30 includes a support leg body 30a and a fixing portion 30b. The support leg body 30a in this embodiment is a flat plate extending in the vertical direction, and the fixing portion 30b is a flat plate extending in the horizontal direction from a lower end of the support leg body 30a. The support leg body 30a in this embodiment is integral with the fixing portion 30b. An elongate hole 30c for fixing the support leg 30 to the base 8 is formed in the fixing portion 30b. A through-hole 30d is formed in the support leg body 30a.

FIG. 8 is a schematic view showing a state in which the support leg 30 shown in FIG. 7 is attached to the length adjustment member 11. As shown in FIG. 8, the support leg 30 is fixed to the protrusions 12c, 12d. More specifically, with the protrusions 12c, 12d of the length adjustment member 11 in contact with each other, the support leg body 30a of the support leg 30 is disposed on the outside of the protrusion 12d. While a position of the through-hole 30d formed in the support leg body 30a coincides with positions of the through-holes 12e, 12f formed in the protrusions 12c, 12d, the bolt 21 is inserted into the through-hole 30d, the through-hole 12f, and the through-hole 12e. The nut 22 is then engaged with the bolt 21. The nut 22 is completely tightened to the bolt 21, so that the support leg 30 is fixed to the protrusions 12c, 12d.

As shown in FIG. 8, a bolt 33 is inserted into the elongate hole 30c of the support leg 30, and is screwed into a threaded hole formed in the base 8, thereby fixing the support leg 30 to the base 8. In this manner, by supporting the length adjustment member 11 with the support leg 30, the length adjustment member 11 is more stably secured to the guard body 13. In particular, when a relatively-long portion of the length adjustment member 11 protrudes from the guard body 13, the support leg 30, which supports the length adjustment member 11, can prevent the length adjustment member 11 from falling out of the guard body 13.

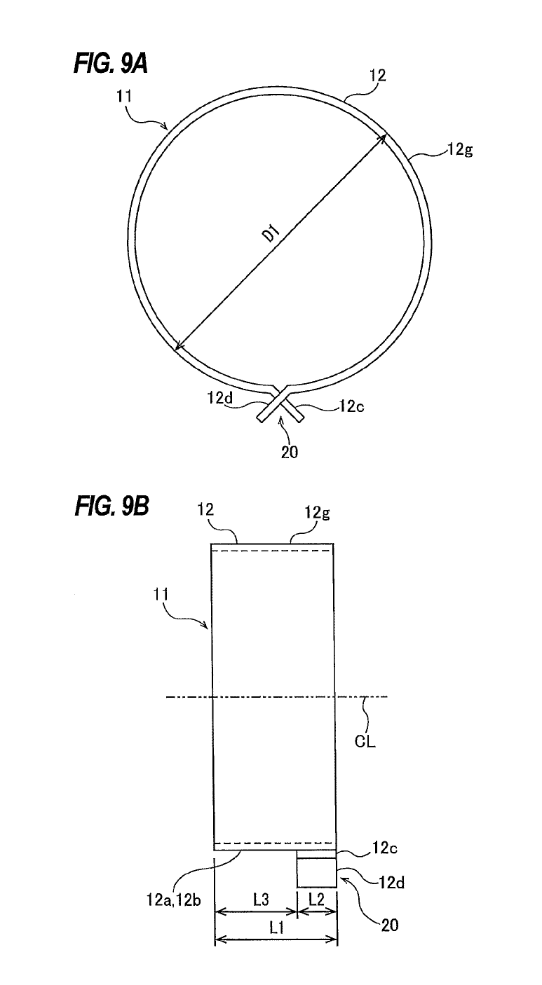

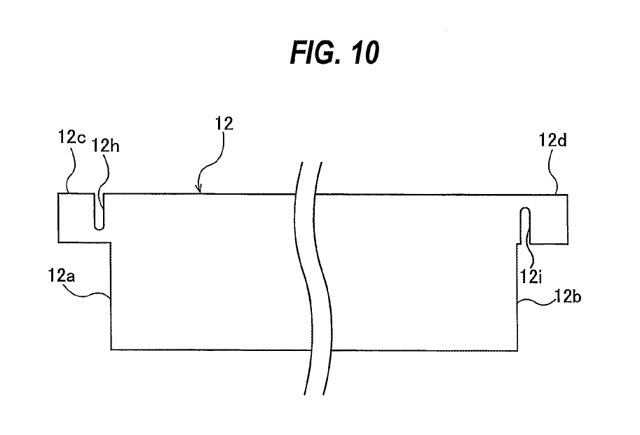

FIG. 9A is a front view of the length adjustment member 11 according to another embodiment, FIG. 9B is a side view of the length adjustment member 11 shown in FIG. 9A, and FIG. 10 is a schematic view showing a plate which constitutes the length adjustment member 11 shown in FIGS. 9A and 9B. Structures that are not described particularly in this embodiment are identical to those of the previously-discussed embodiments, and their repetitive descriptions are omitted.

As with the length adjustment member 11 shown in FIGS. 4A and 4B, the length adjustment member 11 shown in FIGS. 9A and 9B has a cylindrical shape. The length adjustment member 11 of this embodiment includes a single plate 12 which has been bent into a cylindrical shape, protrusions 12c, 12d which are formed on both ends 12a, 12b of the plate 12, respectively, and a fixing mechanism 20 for fixing these protrusions 12c, 12d to each other. The rectangular plate 12 shown in FIG. 10 is bent into the cylindrical shape, and the both ends 12a, 12b of the plate 12 are in contact with each other. The protrusions 12c, 12d are connected to the both ends 12a, 12b of the plate 12, respectively. The protrusions 12c, 12d are integral with the plate 12.

The fixing mechanism 20 shown in FIGS. 9A and 9B comprises slit-shaped cutouts 12h, 12i (see FIG. 10) which are formed in the protrusions 12c, 12d, respectively. The cutout 12h extends parallel to the central axis CL from an outer end surface of the protrusion 12c, and the other cutout 12i extends parallel to the central axis CL from an inner end surface of the protrusion 12c.

When the rectangular plate 12 shown in FIG. 10 is formed into the cylindrical shape, the cutouts 12h, 12i, which are formed in the protrusions 12c, 12d, respectively, are engaged with each other. The length of the plate 12 is designed such that the diameter D1 of the outer circumferential surface 12g of the length adjustment member 11 is slightly larger than the diameter D2 (see FIG. 6) of the inner circumferential surface 13a of the guard body 13.

As with the length adjustment member 11 shown in FIGS. 4A and 4B, the length adjustment member 11 shown in FIGS. 9A and 9B can also be fixed to the guard body 13 at a desired position. Therefore, the length of the coupling guard 1 in the direction of the central axis CL can be adjusted in a non-step manner. Moreover, the length of the coupling guard 1 in the direction of the central axis CL can be adjusted with a simple structure in which the outer circumferential surface 12g of the length adjustment member 11 is simply tightened by the inner circumferential surface 13a of the guard body 13.

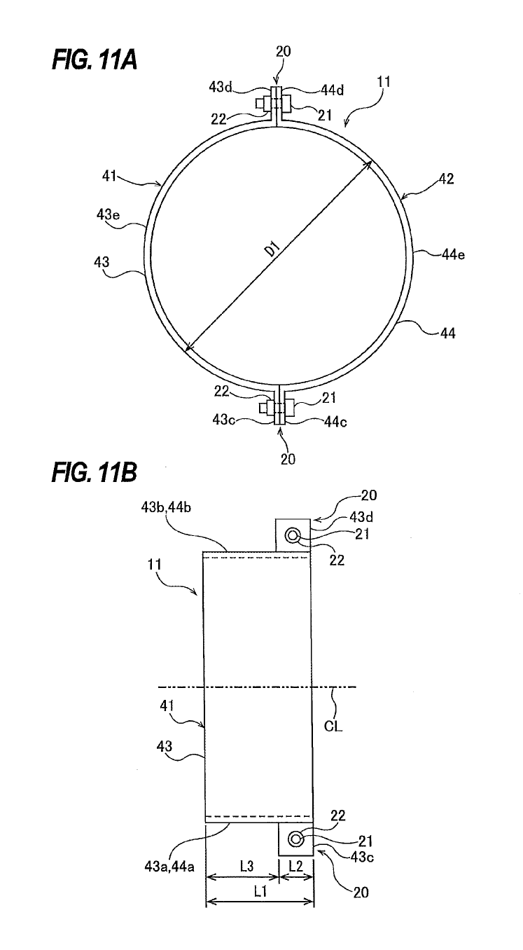

FIG. 11A is a front view of the length adjustment member 11 according to still another embodiment, and FIG. 11B is a side view of the length adjustment member 11 shown in FIG. 11A. The length adjustment member 11 shown in FIGS. 11A and 11B has a cylindrical shape which is constituted by two segments 41, 42 having the same shape. The segment 41 has a semicylindrical shape, and the other segment 42 has also a semicylindrical shape. The segment 41 includes a single plate 43 which has been bent into the semicylindrical shape, and protrusions 43c, 43d which are formed on both ends 43a, 43b of the plate 43, respectively. The protrusions 43c, 43d are connected to the both ends 43a, 43b of the plate 43, respectively, and the protrusions 43c, 43d are integral with the plate 43. Similarly, the segment 42 includes a single plate 44 which has been bent into the semicylindrical shape, and protrusions 44c, 44d which are formed on both ends 44a, 44b of the plate 44, respectively. The protrusions 44c, 44d are connected to the both ends 44a, 44b of the plate 44, respectively, and the protrusions 44c, 44d are integral with the plate 44.

The length adjustment member 11 includes a fixing mechanism 20 by which the protrusion 43c, formed on one end 43a of the plate 43, is secured to the protrusion 44c formed on one end 44a of the plate 44. Similarly, the length adjustment member 11 further includes a fixing mechanism 20 by which the protrusion 43d, formed on the other end 43b of the plate 43, is secured to the protrusion 44d formed on the other end 44b of the plate 44. Since these fixing mechanisms 20 have the same construction, the fixing mechanism 20, by which the protrusion 43c formed on one end 43a of the plate 43 is secured to the protrusion 44c formed on one end 44a of the plate 44, will be described. Descriptions of the fixing mechanism 20 by which the protrusion 43d formed on the other end 43b of the plate 43 is secured to the protrusion 44d formed on the other end 44b of the plate 44 will be omitted.

As shown in FIGS. 11A and 11B, the protrusion 43c extends outwardly in the radial direction of the semicylindrical plate 43 and the guard body 13. The protrusion 44c extends outwardly in the radial direction of the semicylindrical plate 44 and the guard body 13. The protrusion 43c and the protrusion 44c are in contact with each other. The fixing mechanism 20 includes a bolt 21 which is inserted into through-holes formed in the protrusion 43c of the segment 41 and the protrusion 44c of the segment 42, respectively. The fixing mechanism 20 further includes a nut 22 which engages with the bolt 21.

As shown in FIG. 11B, a length L2 of the protrusions 43c, 44c in the direction of the central axis CL is shorter than a length L1 of the plates 43, 44 in the direction of the central axis CL. Portions of the plate 43, 44, at which the protrusions 43c, 44c are not formed, are inserted into the guard body 13 and are held by the guard body 13. A length L3 of these portions corresponds to a distance which can adjust the length of the coupling guard 1.

When the cylindrical length adjustment member 11 is formed, the protrusions 43c, 44c are folded outwardly so as to make contact with each other. Similarly, the protrusions 43d, 44d are folded outwardly so as to make contact with each other (see FIG. 11A). When the protrusions 43c, 44c are in contact with each other, the end portion 43a of the segment 41 is in contact with the end portion 44a of the other segment 42. Similarly, when the protrusions 43d, 44d are in contact with each other, the end portion 43b of the segment 41 is in contact with the end portion 44b of the other segment 42. The through-hole formed in the protrusion 43c is located at the same position as the position of the through-hole formed in the protrusion 44c, so that the bolt 21 can be inserted into these through-holes. Similarly, the through-hole formed in the protrusion 43d is located at the same position as the position of the through-hole formed in the protrusion 44d, so that the bolt 21 can be inserted into these through-holes. The bolts 21, inserted into these through-holes, are tightened by the nuts 22, respectively, whereby the segment 41 and the segment 42 are coupled to each other, thus forming the length adjustment member 11 in the cylindrical shape.

The outer circumferential surface of the length adjustment member 11 is constituted by an outer circumferential surface 43e of the segment 41 and an outer circumferential surface 44e of the segment 42. Lengths of the plates 43, 44 are designed such that the diameter D1 of the outer circumferential surfaces 43e, 44e of the length adjustment member 11 is slightly larger than the diameter D2 (see FIG. 6) of the inner circumferential surface 13a of the guard body 13.

The cylindrical length adjustment member 11 shown in FIGS. 11A and 11B can also be fixed to the guard body 13 at a desired position, as well as the length adjustment member 11 shown in FIGS. 4A and 4B. Therefore, the length of the coupling guard 1 in the direction of the central axis CL can be adjusted in a non-step manner. Moreover, the length of the coupling guard 1 in the direction of the central axis CL can be adjusted with a simple structure in which the outer circumferential surfaces 43e, 44e of the length adjustment member 11 is simply tightened by the inner circumferential surface 13a of the guard body 13.

The cylindrical length adjustment member 11 may comprise three or more segments. Also in the case where the length adjustment member 11 comprises three or more segments, end portions of adjacent segments are secured to each other by the above-described fixing mechanism 20, so that the three or more segments are coupled to each other, thereby forming the length adjustment member 11 having the cylindrical shape.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A coupling guard for covering a coupling which couples a drive shaft of a prime mover and a rotational shaft of a rotary machine to each other, the coupling guard comprising:
a guard body including an upper semicylindrical member and a lower semicylindrical member, the guard body having a fastening tool configured to couple the upper semicylindrical member and the lower semicylindrical member to each other;
a guard leg configured to support the guard body; and
a length adjustment member inserted into the guard body, the length adjustment member having a cylindrical shape, the length adjustment member having an outer circumferential surface which is tightened by inner circumferential surfaces of the upper semicylindrical member and the lower semicylindrical member which are coupled by the fastening tool.

2. The coupling guard according to claim 1, wherein the length adjustment member includes:
a single plate which has been bent into a cylindrical shape;
protrusions formed on both ends of the plate, respectively; and
a fixing mechanism configured to fix the protrusions to each other.

3. The coupling guard according to claim 2, wherein the protrusions extend outwardly in a radial direction of the plate in the cylindrical shape, and are in contact with each other, and
the both ends of the plate are in contact with each other.

4. The coupling guard according to claim 2, wherein the fixing mechanism includes a bolt inserted into through-holes formed in the protrusions, and a nut engaging with the bolt.

5. The coupling guard according to claim 2, further comprising:
a support leg configured to support the length adjustment member, the support leg being secured to the protrusions.

6. The coupling guard according to claim 2, wherein the fixing mechanism comprises cutouts which engage with each other, the cutouts being formed in the protrusions, respectively.

7. The coupling guard according to claim 1, wherein the length adjustment member comprises at least two segments which are coupled to each other to have a cylindrical shape.

8. The coupling guard according to claim 2, wherein the plate is made of metal.
